(19) United States
(12) Patent Application Publication
(10) Pub. No.: US 2013/0043978 A1
(43) Pub. Date: Feb. 21, 2013

(54) Locator Light Switch Plate

(71) Applicant: Darryl E. Brooks, Pasadena, CA (US)

(72) Inventor: Darryl E. Brooks, Pasadena, CA (US)

(21) Appl. No.: 13/461,420

(22) Filed: May 1, 2012

Related U.S. Application Data
(60) Provisional application No. 61/575,255, filed on Aug. 18, 2011.
(60) Provisional application No. 61/590,504, filed on Jan. 25, 2012.

(51) Int. Cl. G08B 5/22

(52) U.S. Cl. 340/8.1

(57) ABSTRACT

Locator light switch plates having remote-locator technology are described herein. The locator light switch plates may be wall-mounted and incorporated with single, double, or triple light switches, providing the user with a stationary location for sending a signal to locate their lost or misplaced keys, or other items. The locator light switch plate has a transmitter that is paired with at least one receiver. The receiver may be attached to the item that the user wishes to locate. When the receiver detects a signal from the transmitter, an audible, visual and/or tactile alert is activated to alert the user to the location of the receiver.

### CROSS-REFERENCE TO RELATED APPLICATIONS

This utility patent application claims priority under 35 U.S.C. §119(e) to U.S. Provisional Patent Application No. 61/590,504, filed on Jan. 25, 2012 and U.S. Provisional Patent Application No. 61/575,255 filed Aug. 18, 2011, the entire contents of which are incorporated by reference herein.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to a locator light switch plate and, more particularly to a locator light switch plate incorporating remote-locator technology into the production of wall-mounted, standard single, double, and triple light switch plates enabling the user to locate their lost keys.

2. Description of the Related Art

Many people misplace keys, cellphones, TV remotes, and wallets. A TV remote, for example, may get lost between couch cushions. Keys are frequently lost and may be very disrupting if it is not quickly located, such as when one is running late for an important meeting or appointment. In addition, many cellular phones are small and are easily misplaced.

A pager system has been used in some products, such as a cordless phone to locate the handset. The pager system sends a signal to a misplaced handset to activate the handset's ringer.

### DESCRIPTION OF THE DRAWINGS

FIG. 1 is a front perspective view illustrating a locator light switch plate having a toggle light switch.

FIG. 2 is a front perspective view illustrating a locator light switch plate having two toggle light switches.

FIG. 3 is a front perspective view illustrating a locator light switch plate having three toggle light switches.

FIG. 4 is a rear view illustrating a locator light switch plate with a transmitter assembly.

FIG. 5 is a front perspective view illustrating a separate transmitter assembly coupled to a light switch plate.

FIG. 6 is a perspective view of a receiver coupled to keys.

### DETAILED DESCRIPTION

Locator light switch plates comprising remote-locator technology are described herein. The locator light switch plates may be wall-mounted and incorporated with single, double, or triple light switches, providing the user with a stationary location to go to for sending a wireless signal for locating their lost or misplaced keys, or other items. A locator light switch plate having desirable features and advantages will now be described with reference to the figures.

The system disclosed herein includes a receiver and a locator light switch plate having a transmitter. The transmitter is paired with at least one receiver. The locator light switch plate may have a transmitter switch that activates the transmitter. The transmitter switch is configured to send a wireless signal to the receiver. The receiver may be attached to the item that the user wishes to locate. When the receiver detects a signal from the transmitter, an audible, visual and/or tactile alert is activated to alert the user to the location of the receiver.

The wall mountable locator light switch plate may save the user time and undue frustration when searching for lost keys (or other items) to which a receiver is coupled. As explained in detail below, the locator light switch plate may include a code system to help prevent unwanted persons (e.g., strangers, teenagers on restriction and other family members) from activating the locator's transmitter. The locator is simple to use and may avert wasting countless seconds, minutes, hours, and perhaps days searching for lost keys and other items just by activating a light switch.

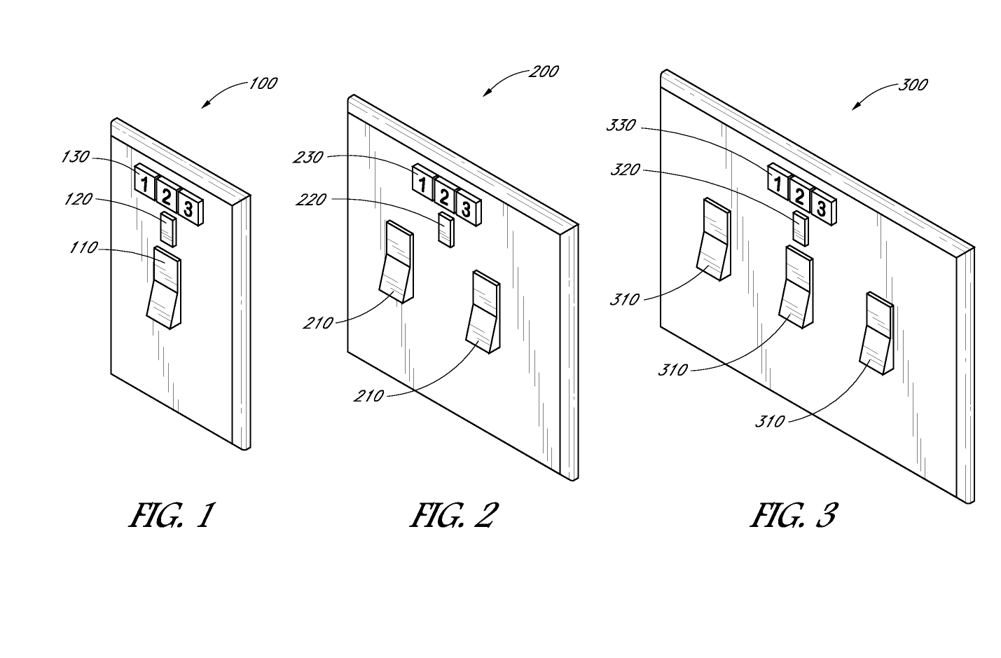

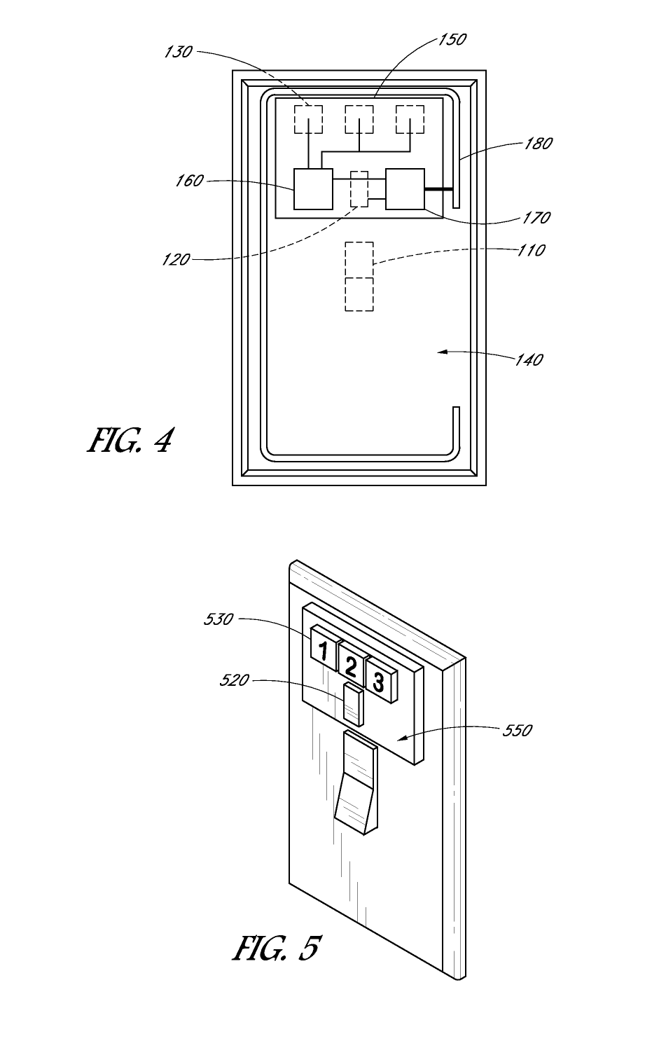

With reference to the figures, the locator light switch plate includes a transmitter and may be integrated into a single, double or triple light switch plate. In other embodiments, the locator light switch plate may be integrated with more than three light switches. The locator light switch plate is standard-sized to fit existing mounting brackets for light switch plates. FIG. 1 illustrates the front view of a locator light switch plate 100 having a single toggle light switch 110, a transmitter switch 120 and a data entry device 130. FIG. 2 illustrates a double toggle light switch plate 200 having two toggle light switches 210, a transmitter switch 220 and a data entry device 230. FIG. 3 illustrates a triple toggle light switch plate 300 having three toggle light switches 310, a transmitter switch 320 and a data entry device 330. Although in the illustrated embodiments the transmitter switch and data entry device are positioned above the light switches, the positions of the transmitter switch and data entry device are not limited to these locations. For example, the transmitter switch and/or data entry device may be located below the light switches.

The locator light switch plate may be used with a plurality of different types of light switches. Some examples of light switch types that may be used in combination with the locator light switch plate include push button light switches, dimmer light switches, motion detector light switches, proximity light switches, timer light switches and photoelectric light switches.

The locator light switch plate 100 may be configured to replace an existing light switch plate for easy installation. The locator light switch plate 100 uses the existing mounting holes for the standard light switch plate and is configured to be used with existing light switches. In some embodiments, the locator light switch plate 100 is configured to mount to the wall and/or the wall opening adjacent to the light switch. In some embodiments, non-standard light switches are used with the locator light switch plate. In these embodiments, the light switches and locator light switch plate may be provided together as a kit. The light switch and the locator light switch plate may be integrated together as a single unit.

The locator light switch plate 100 may include a data entry device 130 incorporated into the light switch plate. The data entry device may be a small touch screen and/or have a plurality of buttons. The locator light switch plates 100, 200 and 300 in FIGS. 1-3 illustrate a data entry device 130, 230 and 330 having a three button key pad. The keys may have numbers, letters, icons, shapes and/or other identifiable graphics printed on them. In other embodiments, the data entry device may be any of a plurality of different types of devices for data entry, such as switches, magnetic readers, etc.

In some embodiments, the data entry device 130 is configured to allow the user to program and enter a code. The code may be used for security purposes to prevent unauthorized persons from activating the locator and finding the user's keys. For example, in the illustrated embodiments, the code may be a combination of digits that may be entered on the button key pad. When the data entry device 130 receives a code from the user that matches an authorized code, the transmitter may immediately send a signal. In some embodiments, when the data entry device 130 receives a matching code from the user, the transmitter is unlocked and available to send a signal when a transmitter switch is activated.

With reference to FIG. 4, the transmitter assembly 150 may be disposed on the rear side 140 of the locator light switch plate 100. The transmitter assembly 150 includes a control unit 160 that is in communication with the data entry device 130. The control unit 160 may also be in communication with a transmitter 170. As described above, when a code is entered on the data entry device 130, the control unit 160 may compare the code with authorized codes stored in a memory included in the transmitter assembly. If the inputted code matches an authorized code, the control unit 160 may communicate to the transmitter 170 to produce a signal. In some embodiments, the control unit 160 may communicate to the transmitter 170 to enable or unlock the transmitter 170, which produces a signal when the transmitter switch 120 is activated.

The transmitter 170 may be an electronic device that produces radio waves. The radio waves may be, for example, 2.4 GHz, 2.45 GHz, 5.8 GHz, 915 MHz, 868 MHz, 315 MHz, 433.92 MHz, and may conform to RFID or other communications standards. In some embodiments, the transmitter 170 may generate an alternating current which is applied to an antenna 180, which is a conductor such as copper. When excited by this alternating current, the antenna 180 radiates radio waves. In some embodiments, the transmitter 170 may be able to receive signals as well, and may be a transceiver. In some embodiments, the transmitter 170 may use other types of signals for communication, such as infrared (IR) bursts.

The antenna 180 may be a thin conductor that extends around the locator light switch plate 100, as illustrated in FIG. 4. In some embodiments, the antenna 180 may be integrated into the light switch plate. The light switch plate may be made of a metal or conductor and may function as the antenna. In some embodiments, the antenna may be compact, such as a wire coiled around a cylinder.

The transmitter assembly 150 is typically generally flush with the rear side 140 so that the locator light switch plate 100 can be mounted over existing cutouts for light switches without modification of the mounting wall and light switch area. In some embodiments, the transmitter assembly 150 may be integrated with the light switch plate and the components of the transmitter assembly 150 may be attached to the light switch plate itself. In some embodiments, the transmitter assembly 150 may protrude from the rear side 140 of the locator light switch plate 100. In some embodiments, the transmitter assembly 150 minimally protrudes from the rear side 140 of the locator light switch plate 100 so that no modification of the mounting wall or existing light switch area is needed. In other embodiments, the transmitter assembly 150 protrudes from the rear side 140 of the locator light switch plate 100 such that modification of the mounting wall may be needed to mount the locator light switch plate 100.

In some embodiments, the transmitter assembly may be a separate component attachable to existing light switch plates. For example, the transmitter assembly may attach to an existing light switch plate using existing mounting hardware, double sided tape or other attachment technology or device. The transmitter assembly may attach to either side of an existing light switch plate depending on the embodiment.

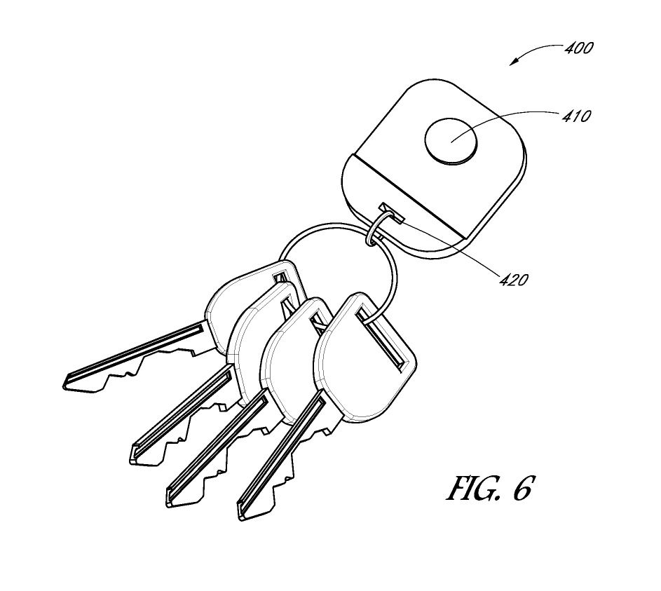

FIG. 5 illustrates a transmitter assembly 550 attached over a standard light switch plate. The transmitter assembly 550 may be a self-contained unit with a data entry device 530 and a transmitter switch 520, as described previously. Although not shown in FIG. 5, the transmitter assembly 550 may have the components discussed herein (i.e., control unit, battery, transmitter and antenna). In some embodiments, the self-contained transmitter assembly 550 may be used in combination with customized light switch plates that are configured to accept the transmitter assembly 550. For example, the customized light switch plate may have a base with an attachment mechanism that is complementary to an attachment mechanism on the transmitter assembly 550 so that the light switch plate and transmitter assembly 550 may couple together without the need for fasteners. In the illustrated embodiment, the transmitter assembly 550 is located above the light switch. In some embodiments, the transmitter assembly 550 can be located on other portions of the light switch plate, such as below the light switch.

In some embodiments, the locator light switch plate 100 may send a variety of wireless signals from the transmitter to activate different receivers. Different buttons, or combination of buttons, may be pressed to select different distinct signals. Each distinct signal may activate a different receiver or group of receivers. For example, to find a user's keys, the user may press a first button or series of buttons on the data entry device 130, which correlates with activating a receiver 400 attached to the user's keys, as illustrated in FIG. 5. To locate the user's cellphone, the user may press a second button or series of buttons on the data entry device 130, which correlates with activating a receiver 400 attached to the user's cellphone. Preprinted discs, tags, and labels may be provided in systems with multiple receivers 400 to identify which buttons or codes correlate to the different items. For example, the labels may allow a user to select from “House Keys”, “Safety Deposit Box Keys”, “Corvette Keys”, “Security Badge”, “Cell Phone”, etc. to designate the different receivers 400.

The different wireless signals may be differentiated based on frequency, band, amplitude modulation, embedded code, etc. For example, a wireless signal with a certain first frequency radio wave may activate a key receiver, while a signal with a different second frequency radio wave may activate a cellphone receiver.

The locator light switch plate 100 may include a transmitter switch 120 that activates the transmitter to emit a signal to the paired receiver 400. The range of the emitted signal may extend from at least a few feet to less than or equal to several hundred feet. In some embodiments, the transmitter switch 120 may be a button that may be pressed, or may be a toggle that is temporarily flipped to the “on” position. The toggle may be biased to automatically return to the “off” position when the user releases the toggle.

The transmitter in the locator light switch plate 100 is powered by a battery. The battery may be compact and low voltage, but appropriate to power a transmitter or micro-transmitter. In some embodiments, the battery may be a disc or coin cell battery. In other embodiments, the battery may be a standard sized compact, cylinder-type battery. The battery may be user accessible and easily serviceable. In another embodiment, the transmitter in the locator light switch plate 100 may be powered by the electrical wires supplied to the light switch.

The locator light switch plate 100 may be made from a variety of materials, such as plastic, metal, nylon, resin or other suitable material. The locator light switch plate 100 may be produced in any color and have a plurality of different textures.

The receiver 400 is portable and may include a small battery-operated microprocessor connected to an antenna that detects the signal sent from the locator light switch plate's transmitter 170. The microprocessor, antenna and battery may be in an enclosure, as illustrated in FIG. 6. The battery may be a disc or coin cell battery. In other embodiments, the battery may be a standard sized compact, cylinder-type battery. The antenna may be wrapped around the enclosure or protrude from the enclosure. In some embodiments, a metal enclosure can be used as the antenna.

The receiver 400 may include an alert device 410, such as a tone emitter, vibrating element, and/or flashing light that is activated when the microprocessor detects the signal. For example, the tone emitter may be a digital tone emitter that produces a loud audible sound to alert the user of the receiver's location. The tone emitter may be sufficiently loud to be heard through objects, such as when the transmitter is in a purse or under couch cushions. In another example, the receiver may have a light-emitting-diode (LED) that produces a bright flashing light to alert the user of the receiver's location. In some embodiments, the receiver may emit a distinct sound or light to notify the user when the level of the battery charge is low. The receiver 400 may include a button or a switch that may be actuated to stop the alert device 410 after the receiver 400 has been found.

The receiver may be small so that it is not obtrusive to the object that it is attached to or unwieldy to the container it is in. In some embodiments, the receiver may have a generally rectangular shape with a small thickness, such as illustrated in FIG. 6. In the illustrated embodiment, the receiver may be less than or equal to approximately 3 centimeters in length, less than or equal to approximately 3 centimeters in width, and less than or equal to approximately 1 centimeter in thickness. However, in some embodiments, the generally rectangular-shaped receiver may have greater dimensions.

In some embodiments, the receiver can have other shapes and sizes. For example, the receiver can have a generally flat, circular shape, similar to a coin. The coin-shaped receiver may have a diameter that is less than or equal to approximately 3 centimeters and a thickness that is less than or equal to approximately 1 centimeter. In some embodiments, the receiver can have a generally cube shape, a generally spherical shape, a generally flat, polygonal shape, or other shape. In some embodiments, the receiver is small and unobtrusive.

The receiver 400 may be made from a variety of materials, such as plastic, metal, nylon, resin or other suitable material. The receiver 400 may be produced in any color and have a plurality of different textures, such as smooth or sandy.

In some embodiments, the receiver can be integrated into a key or a key fob (e.g., an alarm remote or keyless entry remote). For example, the electronics of the receiver may be built into the head of a key. In some embodiments, the receiver can be integrated into a cover that may be coupled with the key or key head. In some embodiments, the receiver can be integrated in a remote that is used to control a home security system, car alarm, or other remote system. The components of the receiver can be built into the key fob and avoid the need for a separate receiver. The key fob receiver embodiment is advantageous because the battery, antenna and some other components of the alarm may be shared and used by the receiver, reducing the number of parts and reducing the manufacturing costs.

The receiver may be integrated with a decorative item, such as a doll or tassels, for example. The decorative item may be attached to a key ring, placed in a purse, or coupled to something else that may become misplaced, as discussed herein. Many people place decorative items on commonly misplaced items, such as key rings and cellphones, so integrating the receiver in decorative items may avoid having too many items attached to the device. For example, the receiver may be included in items the shape of well-known or easily recognizable things or characters, such as a fruit (orange, apple, banana), animal (e.g., dog, cat, horse), car, boat, and many others.

The alert (i.e., sound, light, vibration, etc.) may activate for a predetermined time period or until the user turns off the alert device 410. For example, the alert device 410 may emit an alert and automatically shut off after a few minutes if the user does not turn off the alert device. For example, the alert device may stop activity after a pre-defined time such as, for example, 20 seconds, 30 seconds, 1 minute, 2 minutes, etc. The shut off may help to preserve battery life, particularly when the receiver 400 is accidentally activated. In some embodiments, the alert device 410 may not have an automatic shut-off and will continue emitting a signal until the user turns off the alert device 410. In some embodiments, the user may shut-off the alert device 410 from the locator light switch plate 100 by entering a deactivation code or by turning off the transmitter switch 120. The alert device 410 may shut-off when the signal from the transmitter ceases.

As illustrated in FIG. 6, the receiver 400 may be attached to or coupled with a key or keys. Other examples of objects that may be combined with the receiver 400 include purses, wallets, television remotes, mobile phones, portable computers and pet collars. In some embodiments, the receiver may include a small aperture 420 for accepting a ring to attach to other objects, as illustrated in FIG. 6. In some embodiments, the receiver may be attached to other objects through other methods, such as adhesives, hook and loop fasteners such as VELCRO®, straps, magnets, or clips. As mentioned above, the receiver may be integrated in other devices that are coupled to commonly misplaced items.

In some embodiments, the receiver may be coupled to or integrated with a transmitter. A transmitter-receiver combination is often referred to as a transceiver. The transceiver would be able to transmit information to be received by the transmitter assembly 550 or other device, such as a mobile device, as discussed below. The transmitter assembly 550 or other device would have a receiver to receive the signal from the transceiver. For example, in some embodiments, the transceiver may send a signal that can enable the transmitter assembly 550 or other device to calculate the direction and/or distance of the transceiver, through methods such as signal strength or triangulation. In some embodiments, the transceiver may send other types of information to the transmitter assembly 550 or other device, such as for example battery level, malfunction information, or signal strength of transmitter 170.

In a method of using some embodiments of the locator light switch plate 100 described herein, the user may program a security code, such as a three-digit code, using the data entry device 130 to prevent unauthorized persons from activating the locator. The user may attach the paired receiver 400 to a desired key chain or other item. When the user needs to locate their keys or other item, the user may input the security code and activate the locator light switch plate by pressing the transmitter switch 120. Once activated the user may look for and/or listen for a light, vibration and/or a sound alerting the user to the location of their lost keys or other item.

In some embodiments, the locator light switch plate system operates in conjunction with a mobile device and an installed application (app) in the mobile device. In some embodiments, the mobile device application may work with voice commands. For example, in an embodiment with different paired receivers which are attached to different sets of keys or items, the mobile device app may include a voice command system that prompts a user by asking, for example, “Which item do you need to find?” The user may then answer by identifying the item to be found or by identifying the receiver that is attached to the item to be found.

The mobile device may send a command to the receiver 400 directly. Many mobile devices have infrared transmitters and/or radio wave transmitters that support communication with receiver 400. The mobile device may transmit a signal through its built-in transmitter directly to the appropriate receiver to alert the user of the receiver's location, without going through the locator light switch plate 100. The mobile device may use the same frequencies for the infrared bursts or radio wave signals as the light switch plate 100 when sending a signal to the receiver 400.

In some embodiments, the receiver 400 may include or be a transceiver, as discussed above, and may have a two-way communication with the mobile device and/or the light switch plate. In this embodiment, the mobile device may be able to receive a signal from the receiver 400 and the app on the mobile device may calculate the direction of the receiver 400 through signal strength or other methods mentioned above. The mobile device app may then direct the user to the location of the lost item by displaying an arrow toward the receiver or an audible indication of the proximity of the receiver. A security code or other identifying code may be required by the mobile device app before a signal is transmitted to the receiver.

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Additionally, it will be recognized that the methods described herein may be practiced in different sequences, and/or with additional devices as desired. Such alternative embodiments and/or uses of the methods and devices described above and obvious modifications and equivalents thereof are intended to be included within the scope of the present invention. Thus, it is intended that the scope of the present invention should not be limited by the particular embodiments described above, but should be determined only by a fair reading of the claims that follow.

What is claimed is:

1. A locator system comprising:
a light switch plate mountable over a light switch, the light switch plate comprising:
a transmitter configured to send at least one signal;
a data entry device configured to receive an input code;
a transmitter switch to activate the transmitter; and
at least one portable receiver configured to detect the at least one signal, the receiver comprising an alert device that produces a notification when the at least one signal is detected.

2. The locator system of claim 1, wherein the alert device is an audible sound emitting device.

3. The locator system of claim 1, wherein the alert device is a visible light emitting device.

4. The locator system of claim 1, wherein the alert device is a vibration producing device.

5. The locator system of claim 1, wherein the light switch plate is configured to mount over a single light switch.

6. The locator system of claim 1, wherein the light switch plate is configured to mount over more than one light switch.

7. The locator system of claim 1, wherein the transmitter is configured to send a wireless signal to the portable receiver.

8. The locator system of claim 1, comprising more than one receiver.

9. The locator system of claim 8, wherein the more than one receiver is user selectable using the data entry device.

10. The locator system of claim 1, wherein the transmitter is configured to send more than one distinct signal.

11. The locator system of claim 1, wherein the transmitter is configured to receive a security code from the data entry device before the transmitter switch functions.

12. The locator system of claim 1, wherein the data entry device comprises a touchscreen.

13. The locator system of claim 1, wherein the data entry device comprises a button keypad.

14. The locator system of claim 1, wherein the portable receiver deactivates the alert device after a period of time.

15. The locator system of claim 1, wherein the portable receiver comprises a communications component that allows for communication with a mobile device.

16. A locator light switch plate mountable over a light switch, the locator light switch plate comprising:
a data entry device configured to receive an input code;
a transmitter switch to activate a transmitter;
the transmitter configured to send at least one signal to at least one portable receiver configured to detect the at least one signal and produce a notification when the at least one signal is detected.

17. The locator light switch plate of claim 16, wherein the transmitter is an electronic device that produces radio waves.

18. The locator light switch plate of claim 16, wherein the transmitter is capable of receiving signals.

19. The locator light switch plate of claim 16, wherein the locator light switch plate is configured to mount over a single light switch.

20. The locator light switch plate of claim 16, wherein the locator light switch plate is configured to mount over more than one light switch.

21. The locator light switch plate of claim 16, wherein the transmitter is configured to send more than one distinct signal.

22. The locator light switch plate of claim 16, wherein the transmitter is configured to receive a security code from the data entry device before the transmitter switch functions.

23. The locator light switch plate of claim 16, wherein the data entry device comprises a touchscreen.

24. The locator light switch plate of claim 16, wherein the data entry device comprises a button keypad.
